(19) United States
(12) Patent Application Publication
(10) Pub. No.: US 2012/0003593 A1
(43) Pub. Date: Jan. 5, 2012

(54) METHOD AND APPARATUS FOR PRODUCING A VISIBLE HYDROGEN FLAME

(75) Inventor: Wayne Ernest Conrad, Hampton (CA)

(73) Assignee: G.B.D. CORP, Nassau, BS (BS)

(21) Appl. No.: 12/672,823

(22) PCT Filed: Aug. 10, 2007
(86) PCT No.: PCT/CA07/01381

§ 371 Date: Feb. 9, 2010

(30) Foreign Application Priority Data
Aug. 10, 2007 (CA) PCT/CA2007/001381

(51) Int. Cl. F23J 7/00; F21L 17/00; F21V 37/00; F24B 1/18; F24C 3/02

(52) U.S. Cl. 431/4; 126/512; 126/39 R; 431/126; 126/401

(57) ABSTRACT

A consumer appliance comprises a source of humidified hydrogen; and, a combustion zone in fluid flow communication with a source of oxygen and the source of humidified hydrogen. A method of producing a visible hydrogen flame comprising providing water with hydrogen gas is also provided.

### FIELD OF THE INVENTION

This invention relates to a method and an apparatus for combining water with hydrogen to enhance the visibility of a flame produced by the combustion of hydrogen. In a preferred embodiment, the method and apparatus is used in an apparatus where the flame is intended to be visible, such as in a cooking appliance or in a fireplace, or in an apparatus wherein the flame is exposed, so as to enable a user to perceive the flame and avoid touching the flame, such as a cutting torch.

### BACKGROUND OF THE INVENTION

Fossil fuels or other forms of organic carbon such as wood and charcoal create visible flames in addition to heat when they are combusted. The combustion of fossil fuels is used in many applications which rely on the visibility of the flame as a means of controlling the point of combustion, such as welding, cutting and brazing, while other applications use the flame at least in part as an aesthetic feature, such as fireplaces and fire pits wherein the aesthetic beauty of a flame is important.

### SUMMARY OF THE INVENTION

The combustion of hydrogen typically results in a virtually invisible flame, which may be dangerous for some applications, difficult to control in other applications, and impossible to enjoy for its aesthetic beauty. In accordance with the instant invention, water, and other optional additives, are combined with hydrogen to produce a flame that has enhanced visibility. Accordingly, water is added to hydrogen gas, prior to, or at the point of combustion. The water, preferably in the form of water vapour or atomized water, is used to humidify the hydrogen. The humidity results in a visible flame when the hydrogen is combusted. The humidity is preferably produced by supplying fine water droplets to the combustible gas, upstream of or at the point of combustion.

The combustible gas may have a humidity of greater than 60%, preferably greater than about 75%, more preferably greater than about 90% and most preferably greater than about 98%. Accordingly, it is preferred that the hydrogen gas is substantially saturated with water.

The gas may be humidified in various ways, such as providing a mist of water at the point of combustion, which may be produced by a transducer, humidifying the gas by passing the gas through a water bath, preferably at elevated temperatures, and the like.

The instant invention has applications to make visible a hydrogen flame used to create a number of devices including but not limited to a fixed or portable torch used for cutting, welding or brazing materials, a fixed or portable torch used for illumination and/or heat and/or aesthetic pleasure, a hydrogen fireplace used for heating, and/or cooking and/or aesthetic pleasure, and/or lighting, a hydrogen fire pit, or in a hydrogen flame cooking appliance, or a lighting device.

In one preferred embodiment, by periodically varying the flame characteristics in applications such as fireplaces, it is possible to simulate natural flames produced by burning a hydrocarbon, by having the intensity, brightness, and color of the flame vary over time. For example, a controller may be used to vary the humidity and/or other additives provided with the hydrogen to a combustion zone in a random or predetermined pattern.

In accordance with one embodiment of this invention, there is provided a consumer appliance comprising:
(a) a source of humidified hydrogen; and,
(b) a combustion zone in fluid flow communication with a source of oxygen and the source of humidified hydrogen.

In one embodiment, the source of humidified hydrogen comprises a reactor wherein water is combined with hydrogen.

In another embodiment, the source of humidified hydrogen comprises an atomizer.

In another embodiment, the source of humidified hydrogen further comprises a reactor wherein atomized water is combined with hydrogen.

In another embodiment, the humidified hydrogen has a humidity of greater than 60%.

In another embodiment, the humidified hydrogen has a humidity of greater than 75%.

In another embodiment, the humidified hydrogen has a humidity of greater than 90%.

In another embodiment, the humidified hydrogen has a humidity of greater than 98%.

In another embodiment, the consumer appliance further comprises an adjustment member that varies the amount of humidity in the hydrogen.

In another embodiment, the adjustment member varies the contact time of the hydrogen and a source of water.

In another embodiment, the consumer appliance further comprises a transducer that produces an amount of atomized water and the adjustment member varies at least one of the amount of water that is produced and the size of atomized droplets that are produced.

In another embodiment, the appliance is a fixed cutting torch, a portable cutting torch, a fixed welding torch, a portable welding torch, a fixed brazing apparatus, a portable brazing apparatus, a fixed torch used for illumination, a portable torch used for illumination, a fixed torch used for heat, a portable torch used for heat, a fireplace, a fire pit, a cooking appliance, a heater, a candle or a candelabra.

In another embodiment, the appliance is a torch, a fireplace, a fire pit, a cooking appliance, a heater, a candle or candelabra.

In accordance with another embodiment of this invention, there is provided a method of producing a visible hydrogen flame comprising:
(a) combining water and hydrogen; and
(b) combusting the hydrogen.

In one embodiment, step (a) comprises exposing hydrogen to water vapour.

In another embodiment, step (a) comprises exposing hydrogen to atomized water.

In another embodiment, the hydrogen has a humidity of greater than 60% prior to being combusted.

In another embodiment, the hydrogen has a humidity of greater than 75% prior to being combusted.

In another embodiment, the hydrogen has a humidity of greater than 90% prior to being combusted.

In another embodiment, the hydrogen has a humidity of greater than 98% prior to being combusted.

In another embodiment, the hydrogen is combusted in an apparatus and the method further comprises adjusting the amount of humidity in the hydrogen during the operation of the apparatus.

In another embodiment, the humidity is adjusted to simulate a flame produced by burning a hydrocarbon fuel.

In another embodiment, the humidity is adjusted by a user of the apparatus.

In another embodiment, the humidity is adjusted by varying at least one of the contact time of the water and the hydrogen, the amount of water to which the hydrogen is exposed and the size of water droplets to which the hydrogen is exposed.

In another embodiment, the method is used in a fixed cutting torch, a portable cutting torch, a fixed welding torch, a portable welding torch, a fixed brazing apparatus, a portable brazing apparatus, a fixed torch used for illumination, a portable torch used for illumination, a fixed torch used for heat, a portable torch used for heat, a fireplace, a fire pit, a cooking appliance, a heater, a candle or a candelabra.

In another embodiment, the method is used in a torch, a fireplace, a fire pit, a cooking appliance, a heater, a candle or candelabra.

### BRIEF DESCRIPTION OF THE DRAWINGS

For a better understanding of the present invention and to show more clearly how it may be carried into effect, reference will now be made by way of example to the accompanying drawings, of the preferred embodiments of the present invention, in which:

FIG. 1 is schematic drawing of a first embodiment of the invention;

FIG. 2 is schematic drawing of a second embodiment of the invention;

FIG. 3 is schematic drawing of a third embodiment of the invention;

FIG. 4 is schematic drawing of a fourth embodiment of the invention; and,

FIG. 5 is schematic drawing of a fifth embodiment of the invention.

### DESCRIPTION OF THE PREFERRED EMBODIMENTS

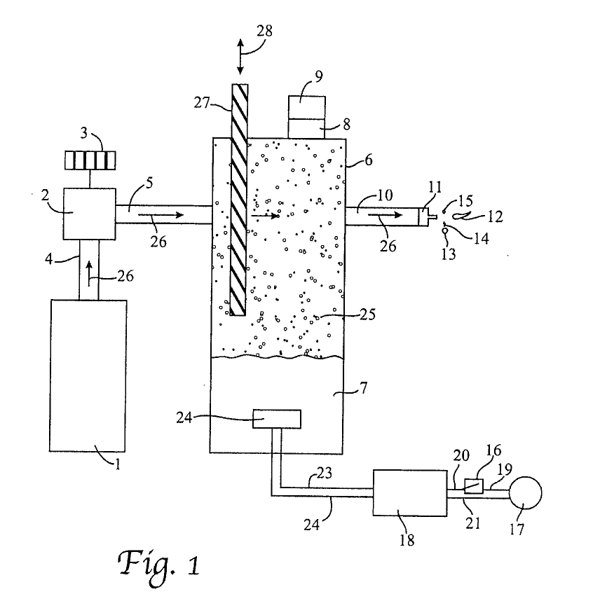

FIG. 1 exemplifies one preferred embodiment of the instant invention wherein hydrogen gas is humidified by contacting the gas stream with atomized water. As shown therein, a vessel 1 (a source of hydrogen) contains hydrogen in the form or a pressurized gas, a refrigerated and/or pressurized liquid, as a metal hydride, or adsorbed into a mechanical structure such as carbon nano-tubes or any other means of hydrogen storage currently known in the art or which may be invented. Alternately, the source of hydrogen may be an electrolyzer. The electrolyzer may produce a stream of oxygen and hydrogen or a stream of oxygen and a stream of hydrogen.

Water 7 is added into chamber 6 (a reactor), such as by means of fill port 8, which may be selectively covered or closed by closure means 9. When the device is to be used, a valve 2 may either be actuated by a mechanical means 3, such as a rotatable handle as is known in the art, or by means of a solenoid, not shown. When the valve 2 is opened, hydrogen gas 26 passes through tube 4, through valve 2, through tube 5 and into chamber 6 and out through tube 10 and into the nozzle tip 11. The hydrogen gas 26 may be ignited by any means known in the combustion arts, such as a hot wire 15 or a high voltage electrode 13 producing a spark 14 or by means of an externally applied ignition source such as a match or a flint striker or a combination thereof. At this point, flame 12 produced by the combustion of the hydrogen 26 is essentially invisible or very difficult to see for the human observer.

When the switch 16 is activated, either manually or by an electronic control means, power from the electrical power source 17 is permitted to flow to the high frequency power supply 18, through wires 19, 20 and 21. The power source may be a power supply driven from line voltage or electricity derived from a battery, fuel cell, solar cell, generator, thermopile or any other voltage or current source known in the art. The high frequency power supply provides electrical energy through wires 22 and 23 to a transducer 24, which creates a fine atomized water droplet mist 25 by the mechanical agitation of the water 7.

When the hydrogen gas passes 26 through the chamber 6 once transducer 24 is actuated, it is mixed with the fine atomized water droplet mist 25, which produces a combustible fluid or gas, which creates a visible flame when combusted.

The characteristics of the water droplets, such as mean particle size, particle size distribution, and density are all factors which can be used to modify flame intensity and/or color and/or temperature and/or thermal energy (btu/second). Accordingly, the intensity and/or color and/or temperature and/or thermal energy (btu/second) of the flame may be controlled by varying the amount of water, size of water droplets, etc. provided to the gas stream. For example, one or more of the contact time between the hydrogen gas 26 and the water droplet mist 25, the density of the water droplet mist, the average size of the water droplets, the droplet size distribution of the water droplet mist 25 may be varied, such as by varying the frequency or voltage or current available to the transducer 24 creating the mist 25.

Alternately, or in addition, a mechanical dam 27 can optionally be moved in an axis such as 28 within the chamber 6 to modify the path length of the hydrogen gas 26 within the water droplet mist 25 contained within chamber 6 thereby modifying the contact time between the hydrogen gas 26 and the water droplet mist 25 thereby modifying the visible flame intensity and/or color and/or temperature and/or thermal energy (btu/second) available.

Alternately, or in addition, it is understood that in this embodiment and all other embodiments described herein, a series of fixed dams and the use of valves to control the flow of the hydrogen gas through the water droplet mist 25 within the chamber 26 may also optionally be employed.

Alternately, or in addition, it is also understood that in this and all other embodiments described herein, mechanical means to circulate the water droplet mist 25 may also be used to modify the contact time with the hydrogen gas 26.

Alternately, or in addition, it is also understood that in this embodiment and all other embodiments described herein, the tube 5 may form a tangential inlet with the changer 6 thereby creating a cyclonic flow within the chamber 6 thereby allowing the contact between the hydrogen gas 26 and the water droplet mist 25 to be further controlled.

Alternately, or in addition, it this embodiment and all other embodiments disclosed herein, it is also possible to add to the water 7 other fluids including combustible fluids or combinations of such fluids including but not limited to alcohol, methylated spirits, turpentine, gasoline, diesel fuel, paraffin oil, in place of the water 7 to control intensity and/or color and/or temperature and/or thermal energy (btu/second) available in the flame.

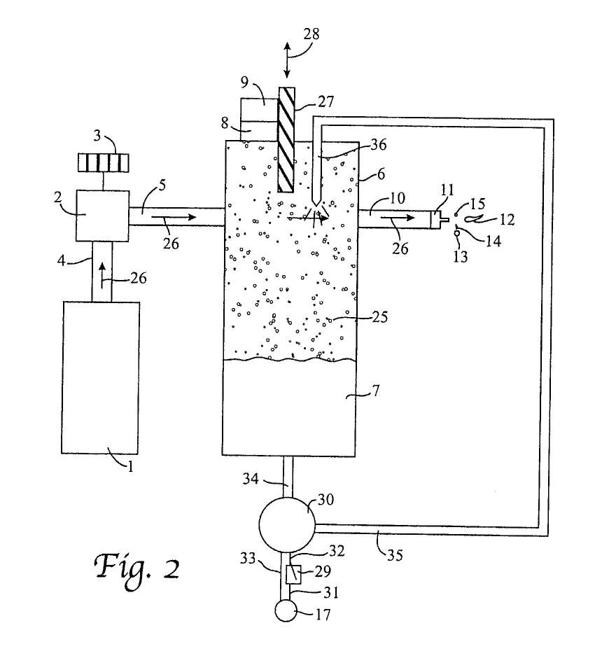

FIG. 2 exemplifies another preferred embodiment for providing atomized water to the combustible gas wherein a water pump and impact member are used. In accordance with this embodiment, when the switch 29 is activated, either manually or by an electronic control means, power from the electrical power source 17 is permitted to flow to the pump 30 through wires 31, 32, and 33. The pump 30 may optionally incorporate or employ an external electronic or electromechanical control to control its flow rate on proportion to the flow rate of the hydrogen gas 26 wherein the control means is not shown herein. The optional integral or external electronic or electromechanical control for the pump 30 may also control the frequency and duration of the pump pulses or the speed of the pump or the on/off duty cycle or the pump, or the pressure pulse characteristics of the pump, or a combination thereof to create the desired water droplet characteristics and to allow the user to vary said characteristics to modify the flame intensity and/or color and/or temperature and/or thermal energy (btu/second). Pump 30 pumps the water 7 through tubes 34 and 35 and to the atomizing nozzle 36, which creates a mist either by direct atomization of the fluid or by directing the water spray against a mechanical target thereby creating the desired atomization.

As in the embodiment of FIG. 1, an optional mechanical dam 27 may be moved in an axis such as 28 within the chamber 6 to modify the path length of the hydrogen gas 26 within the water droplet mist 25 contained within chamber 6 thereby modifying the contact time between the hydrogen gas 26 and the water droplet mist 25 thereby modifying the visible flame intensity and/or color and/or temperature and/or thermal energy (btu/second) available.

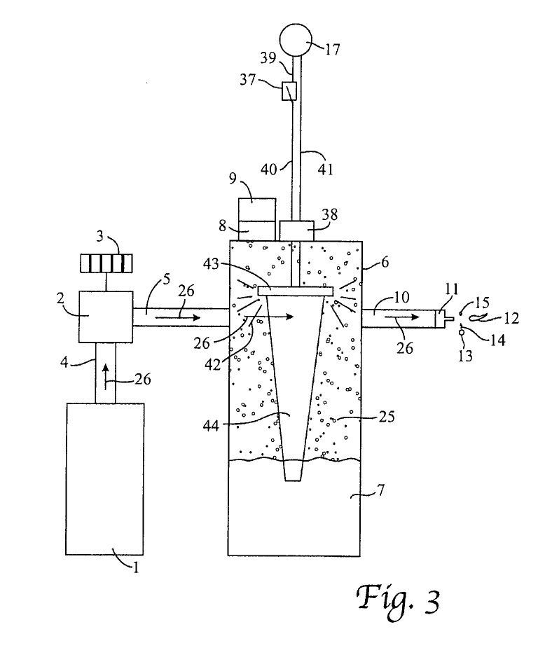

FIG. 3 exemplifies another preferred embodiment for providing a mist of water droplets to the combustible gas. When the switch 37 is activated, either manually or by an electronic control means, power from the electrical power source 17 is permitted to flow to the motor 38 through wires 39, 40, and 41. The rotation of motor 38 produces spray 42 from the disc 43 and the cone 44, which serve to pump the water 7.

The motor 38 may optionally incorporate or employ an external electronic or electromechanical control to control its rotation speed, acceleration and deceleration, or a combination thereof so as to control the mean particle size and or particle size distribution and/or density of the water droplet mist 25 produced. Optionally, the rotation speed, acceleration and deceleration, or a combination thereof may be set based upon the flow rate of the hydrogen gas 26.

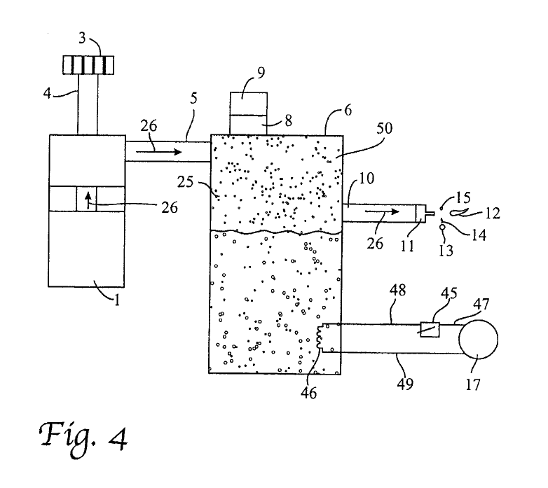

FIG. 4 exemplifies another preferred embodiment wherein steam is combined with the combustible gas. When the switch 45 is activated, either manually or by an electronic control means, power from the electrical power source 17 is permitted to flow to the heating element 46 through wires 47, 48 and 49. This electrical resistance heating (or other heat source) causes steam 50 to be formed in the headspace of the chamber 6. The pressure and temperature and saturation level of the steam 50 will modify the flame intensity and/or color and/or temperature and/or thermal energy (btu/second) when the hydrogen gas 26 is mixed with said steam 50 within chamber 6 and subsequently combusted to form flame 12. The energy input to the heating element 46 may optionally be controlled based upon the pressure in the system or the hydrogen flow rate or a combination therefore to allow stable flame characteristics to be established. It is also understood that by varying the contact time between the hydrogen gas 26 and the steam 50 the flame intensity and/or color and/or temperature and/or thermal energy (btu/second) can be modified.

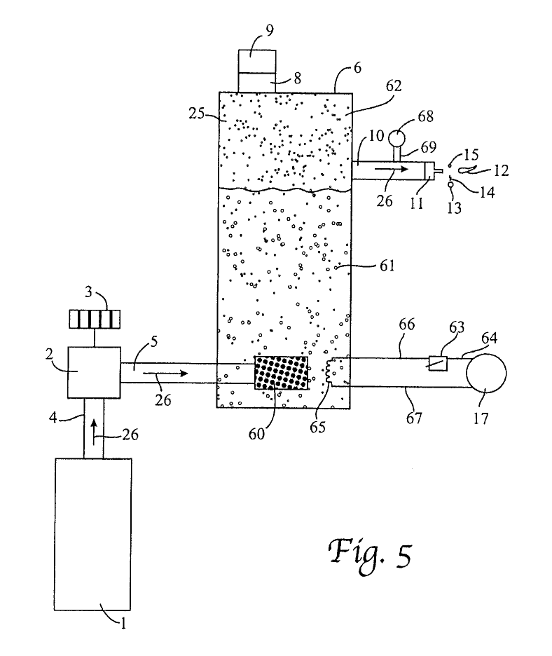

FIG. 5 exemplifies another preferred embodiment of the instant invention wherein a sparger is utilized to humidify hydrogen gas. As shown therein, when the valve 2 is opened, hydrogen gas 26 passes through tube 4, through valve 2, through tube 5 and into chamber 6 and through a sparger 60, which creates fine gas droplets 61, which bubble through the water 7 and emerge in the heated space 62 above the water 7 within chamber 6. The gas then passes through tube 10 and into the nozzle tip 11. The hydrogen gas 26 is ignited such as by means of a hot wire 15 or a high voltage electrode 13 producing a spark 14 or by means of an externally applied ignition source such as a match or a flint striker or a combination thereof. At this point the flame 12 produced by the combustion of the hydrogen 26 has a degree of visibility by a human observer (e.g. a user of a consumer appliance).

Optionally, if provided, water 7 may be able to be heated. Water 7 may be heated by any means. Preferably, water 7 is heated by electrical resistance heating.

For example, as exemplified in FIG. 5, when the switch 63 is activated, either manually or by an electronic control means, power from the electrical power source 17 is permitted to flow to the optional heating element 65 through wires 64, 66 and 67 which causes water 7 to be heated and increases the amount of mist 25 which forms in the head space 25. If the temperature of the water 7 is sufficiently elevated, the mist 25 in the headspace 62 of the chamber 6 also includes steam. The droplet mean size, droplet size distribution and droplet density, and optionally the pressure and temperature and saturation level of the steam within the head space 62 will modify the flame intensity and/or color and/or temperature and/or thermal energy (btu/second) when the hydrogen gas 26 is mixed with the droplets and/or steam in head space 62 of chamber 6 and subsequently combusted to form flame 12.

The energy input to the heating element 65 may optionally be controlled based upon the desired flame intensity and/or color and/or temperature and/or thermal energy (btu/second). Optionally, an air pump or other pressurized gas source 68 may pass gas through tube 69 into tube 10 thereby diluting the hydrogen gas and increasing the gas flow volume thereby increasing the gas velocity within the nozzle 11 thereby modifying the hydrogen flame intensity and/or color and/or temperature and/or thermal energy (btu/second).

The use of an air pump or other pressurized gas source may be used to dilute the hydrogen gas anywhere within the gas circuit and to increase the gas velocity within the nozzle 11 thereby modifying the hydrogen flame intensity and/or color and/or temperature and/or thermal energy (btu/second) in any of the preferred embodiments, alone or in combination with one or more of the other optional features described herein.

Additional elements such as a water filled sparger chamber and/or a solenoid-activated valve may be incorporated into tube 10 to regulate the gas flow and to prevent flashbacks in the system in any of the preferred embodiments, alone or in combination with one or more of the other optional features described herein.

It is understood that, in any of the preferred embodiments, alone or in combination with one or more of the other optional features described herein, any of the embodiments may be controlled based upon the flame intensity and/or color and/or temperature and/or thermal energy (btu/second) by means of a feedback loop control rather than a more open loop control.

It is also understood that, in any of the preferred embodiments, alone or in combination with one or more of the other optional features described herein, the vessel 1 which contains the hydrogen may alternatively be substituted with one or more of any hydrogen generator known including fuel reformers, a generator employing electrolysis or thermal hydrogen generators driven by batteries, solar energy, nuclear energy, or any other means or combination of means known in the art. Accordingly, the gas provided to reactor 6 may be hydrogen by itself or a mixture of hydrogen with other gasses, such as oxygen or air. The hydrogen may be generated from power derived primary or secondary from batteries, hydro, solar energy, wind energy nuclear energy, or any other means or combination of means and any hydrogen storage means known in the art.

It is also understood that, in any of the preferred embodiments, alone or in combination with one or more of the other optional features described herein, the vessel 1 which contains the hydrogen may alternatively be substituted with a vessel containing a mixture of hydrogen and oxygen and/or other gases.

It is also understood that, in any of the preferred embodiments, alone or in combination with one or more of the other optional features described herein, the vessel 1 which contains the hydrogen may alternatively be substituted with a device which employs electrolysis to produce a mixture of hydrogen and oxygen and may be powered by the power grid or by primary or secondary batteries, hydro, solar energy, wind energy, nuclear energy, or any other means known in the art.

1) A consumer appliance comprising:
a) a source of humidified hydrogen; and,
b) a combustion zone in fluid flow communication with a source of oxygen and the source of humidified hydrogen.

2) The consumer appliance of claim 1 wherein the source of humidified hydrogen comprises a reactor wherein water is combined with hydrogen.

3) The consumer appliance of claim 1 wherein the source of humidified hydrogen comprises an atomizer.

4) The consumer appliance of claim 2 wherein the source of humidified hydrogen further comprises a reactor wherein atomized water is combined with hydrogen.

5) The consumer appliance of claim 1 wherein the humidified hydrogen has a humidity of greater than 60%.

6) The consumer appliance of claim 1 wherein the humidified hydrogen has a humidity of greater than 75%.

7) The consumer appliance of claim 1 wherein the humidified hydrogen has a humidity of greater than 90%.

8) The consumer appliance of claim 1 wherein the humidified hydrogen has a humidity of greater than 98%.

9) The consumer appliance of claim 1 further comprising an adjustment member that varies the amount of humidity in the hydrogen.

10) The consumer appliance of claim 9 wherein the adjustment member varies the contact time of the hydrogen and a source of water.

11) The consumer appliance of claim 9 further comprising a transducer that produces an amount of atomized water and the adjustment member varies at least one of the amount of water that is produced and the size of atomized droplets that are produced.

12) The consumer appliance of claim 1 wherein the appliance is a fixed cutting torch, a portable cutting torch, a fixed welding torch, a portable welding torch, a fixed brazing apparatus, a portable brazing apparatus, a fixed torch used for illumination, a portable torch used for illumination, a fixed torch used for heat, a portable torch used for heat, a fireplace, a fire pit, a cooking appliance, a heater, a candle or a candelabra.

13) The consumer appliance of claim 1 wherein the appliance is a torch, a fireplace, a fire pit, a cooking appliance, a heater, a candle or a candelabra.

14) A method of producing a visible hydrogen flame comprising:
a) combining water and hydrogen; and
b) combusting the hydrogen.

15) The method of claim 14 wherein step (a) comprises exposing hydrogen to water vapour.

16) The method of claim 14 wherein step (a) comprises exposing hydrogen to atomized water.

17) The method of claim 14 wherein the hydrogen has a humidity of greater than 60% prior to being combusted.

18) The method of claim 14 wherein the hydrogen has a humidity of greater than 75% prior to being combusted.

19) The method of claim 14 wherein the hydrogen has a humidity of greater than 90% prior to being combusted.

20) The method of claim 14 wherein the hydrogen has a humidity of greater than 98% prior to being combusted.

21) The method of claim 1 wherein the hydrogen is combusted in an apparatus and the method further comprises adjusting the amount of humidity in the hydrogen during the operation of the apparatus.

22) The method of claim 21 wherein the humidity is adjusted to simulate a flame produced by burning a hydrocarbon fuel.

23) The method of claim 21 wherein the humidity is adjusted by a user of the apparatus.

24) The method of claim 21 wherein the humidity is adjusted by varying at least one of the contact time of the water and the hydrogen, the amount of water to which the hydrogen is exposed and the size of water droplets to which the hydrogen is exposed.

25) The method of claim 21 wherein the method is used in a fixed cutting torch, a portable cutting torch, a fixed welding torch, a portable welding torch, a fixed brazing apparatus, a portable brazing apparatus, a fixed torch used for illumination, a portable torch used for illumination, a fixed torch used for heat, a portable torch used for heat, a fireplace, a fire pit, a cooking appliance, a heater, a candle or a candelabra.

26) The method of claim 21 wherein the method is used in a torch, a fireplace, a fire pit, a cooking appliance, a heater, a candle or a candelabra.
